(19) United States
(12) Patent Application Publication
(10) Pub. No.: US 2008/0189608 A1
(43) Pub. Date: Aug. 7, 2008

(54) METHOD AND APPARATUS FOR IDENTIFYING REVIEWED PORTIONS OF DOCUMENTS

(75) Inventor: Mikko Nurmi, Tampere (FI)

Correspondence Address: PERMAN & GREEN, 425 POST ROAD, FAIRFIELD, CT, 06824, US

(73) Assignee: NOKIA CORPORATION, Espoo (FI)

(21) Appl. No.: 11/669,474

(22) Filed: Jan. 31, 2007

(51) Int. Cl. G06F 17/00

(52) U.S. Cl. 715/273; 715/256

(57) ABSTRACT

A method including opening a document application in a device, determining in the device which sections of a document associated with the application have been reviewed and automatically highlighting the reviewed sections.

### BACKGROUND

1. Field

The disclosed embodiments generally relate to computerized devices, and in particular to, document applications on computerized devices.

2. Brief Description of Related Developments

As computer technology increases and becomes more readily available to an increasing number of users, more and more people are reading documents using the internet, word processors or any other type of document viewer. The users may also create documents using computers. The viewer of a document may want to keep track of which portions of the document or documents have been viewed by other people. A viewer of a document may also want to keep track of which portions of the document or documents have been read so that the viewer does not have to re-read or skim over the document to determine where the viewer previously stopped reading.

Currently when viewing a document such as, for example, word processing documents, spreadsheets and web pages there is no automated way for a viewer of the document to tell which portions of that document the viewer or other viewers have reviewed or otherwise look at. In, for example, the case where a document is to be reviewed by others the creator of the document has to scroll through the document to see if any changes were made. In another example, when a viewer of a document reads a portion of the document and has stop reading for some reason, the viewer of the document has to re-read the document or at least skim over document content previously viewed to figure out where the viewer stopped reading when the viewer wants to resume reading the document.

It would be advantageous to identify which portions of a document have been read or reviewed without scrolling or skimming through the document contents.

### SUMMARY

In one aspect, the disclosed embodiments are directed to a method. In one embodiment, the method includes opening a document application in a device, determining in the device which sections of a document associated with the application have been reviewed and automatically highlighting the reviewed sections.

In another aspect, the disclosed embodiments are directed to an apparatus. In one embodiment, the apparatus includes a display, a detection unit configured to determine which sections of a document are reviewed and a processor connected to the display and detection unit. The processor being configured to mark the reviewed sections of the document and present an indication of the marked sections to a user through at least the display.

In another aspect, the disclosed embodiments are directed to a computer program product. In one embodiment the computer program product includes a computer useable medium having computer readable code means embodied therein for causing a computer to automatically highlight reviewed sections of a document. The computer readable code means in the computer program product including computer readable program code means for causing a computer to open a document application in a device, computer readable program code means for causing a computer to determine in the device which sections of a document associated with the application have been reviewed and computer readable program code means for causing a computer to automatically highlight the reviewed sections.

### BRIEF DESCRIPTION OF THE DRAWINGS

The foregoing aspects and other features of the embodiments are explained in the following description, taken in connection with the accompanying drawings, wherein:

FIG. 1 shows a schematic illustration of an apparatus, as an example of an environment in which aspects of the embodiments may be applied;

FIG. 2 illustrates a flow diagram of a method in accordance with aspects of an embodiment;

FIG. 3 illustrates a table in accordance with an embodiment;

FIG. 4 illustrates a flow diagram of a method in accordance with aspects of an embodiment;

FIG. 5 a flow diagram of a method in accordance with aspects of the disclosed embodiments;

FIG. 6 a flow diagram of a method in accordance with aspects of the disclosed embodiments;

FIG. 7 illustrates a screen display in accordance with aspects of an embodiment;

FIG. 8 illustrates a screen display in accordance with aspects of an embodiment;

FIG. 9 illustrates a screen display in accordance with aspects of an embodiment;

FIG. 10 illustrates a progress bar in accordance with aspects of an embodiment;

FIG. 11 illustrates a device in accordance with an embodiment;

FIG. 12 illustrates a device in accordance with an embodiment;

FIG. 13 is a block diagram illustrating the general architecture of the exemplary device in which aspects of the disclosed embodiments may be implemented;

FIG. 14 is a schematic illustration of a cellular telecommunications system, as an example, of an environment in which a communications device incorporating features of an embodiment may be applied; and

FIG. 15 illustrates a block diagram of one embodiment of a typical apparatus incorporating features that may be used to practice aspects of the invention.

### DETAILED DESCRIPTION OF THE EMBODIMENT(S)

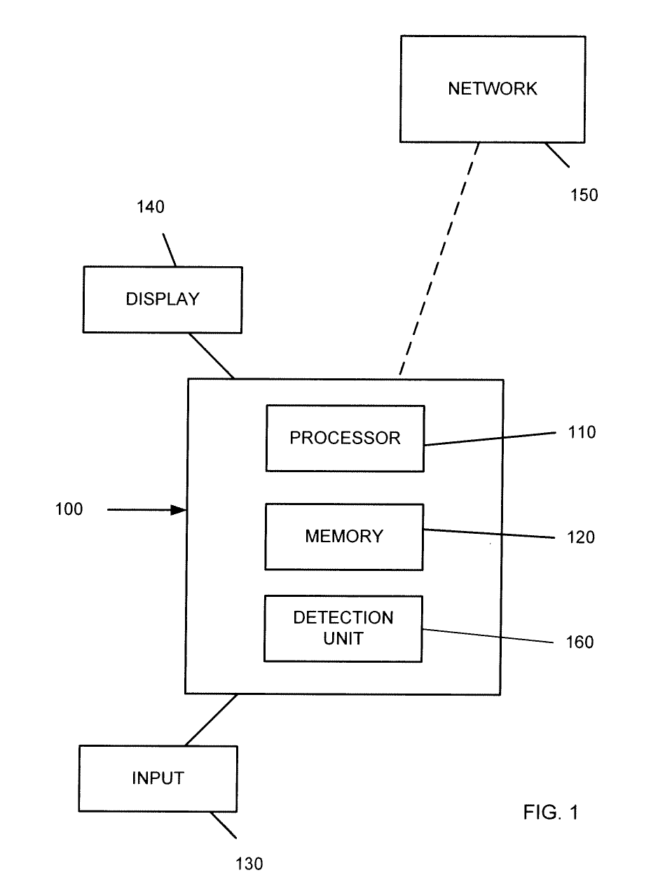

Referring to FIG. 1, one embodiment of an apparatus 100 is illustrated that can be used to practice aspects of the disclosed embodiments. Although aspects of the disclosed embodiments will be described with reference to the embodiments shown in the drawings and described below, it should be understood that these aspects could be embodied in many alternate forms of embodiments. In addition, any suitable size, shape or type of elements or materials could be used.

The disclosed embodiments generally allow a user to determine which portions of a document have been previously viewed or read by the user or by other people. The term “document,” as used herein, generally includes, but is not limited to, word processor documents, spreadsheets, web pages, word pad entries, calendar entries, drawings, photographs, video images, still images, slide shows, electronic books (e.g. Ebooks), electronic mail or other messages and music tracks. Generally, a document can encompass any application that provides information to a user in a manner to be viewed, listened to or read. In accordance with the disclosed embodiments, the user opens the document in an application of the device. As the user reads the document, the device determines which portions or sections of the document have been read or reviewed. The document or page of the document is marked to provide the user with an indication of what has been read or reviewed as will be described in greater detail below. The indicators pertaining to which portions of a document are read or reviewed by viewers may allow the author or creator of the document to see which parts of the document have been read or checked by others and which parts of the document require further reading or review. The information may provide data relating to which portions of a document a reader or viewer finds most interesting. The information may also provide a way to keep track of which portions of a document a reader has already read when the reading of the document takes place over one or more reading sessions so that the reader does not have to re-read or skim through the document to find out where the reader stopped reading.

In one example indicators are configured to provide an indication as to which portions of a document(s) the viewer has already read and which portions require further reading. In another example, the indicators are configured to provide an indication as to which portions of a document have been reviewed by others such as when, for example, a document is viewed on the same apparatus by different users or when the document is shared over a network or sent to reviewers via electronic mail, any suitable message (e.g. short message service (SMS), multimedia message service (MMS)) and the like.

In one embodiment, the apparatus 100 incorporates features of the disclosed embodiments. As used herein the term apparatus includes, but not limited to, mobile communication devices, desktop computers, laptop computers, tablet PCs and personal data assistants (PDA). The apparatus 100 includes a memory 120 and a detection unit 160 connected to the processor 110. The detection unit 160 or any other suitable component of the apparatus 100 may be configured to detect or track which portions of a document(s) have been viewed as well as which user or viewer of the document(s) has viewed those portions as will be described in greater detail below. Software, hardware or a combination of software and hardware may implement or comprise the detection unit 160. The apparatus 100 may also include a display 140 and an input unit 130. The display 140 and the input 130 may be integral to the apparatus 100 or they may be a peripheral device suitable connected to the apparatus 100. The input 130 may include, but is not limited to, keypads, touch enabled devices, voice recognition and the like.

The apparatus 100 may be connected to a suitable network such as, for example, network 150 for receiving, sending and viewing documents. The network may be any suitable network such as, for example, one or more of the internet or worldwide web, a local area network, a wide area network, a telecommunications network and the like.

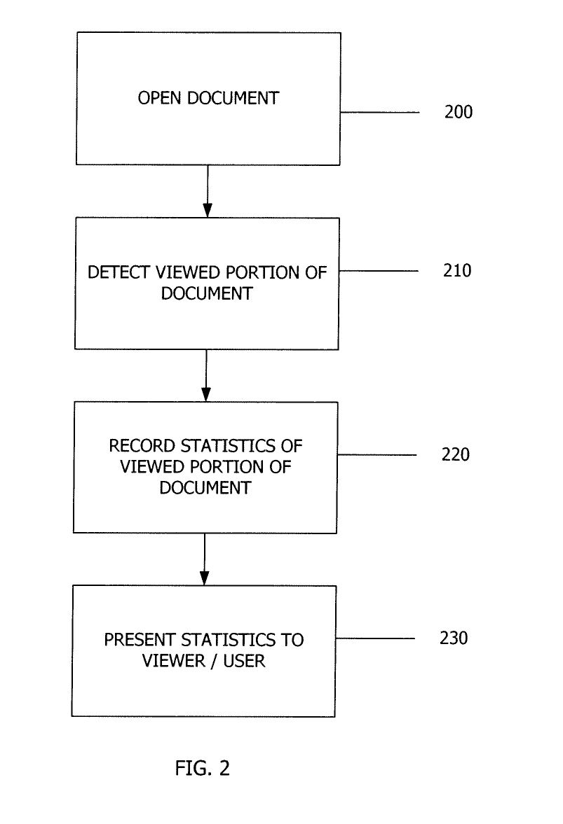

Referring now to FIG. 2, a method incorporating features of the disclosed embodiments will be described. The user opens a document (FIG. 2, Block 200). This can include for example, opening a word processing document or accessing a web page. As the user reads or reviews the document the detection unit 160 or any other suitable hardware or software, for example, determines which portions of the document have been read or reviewed (FIG. 2, Block 210). In one embodiment the detection unit 160 determines which portions of the document are viewed by tracking or detecting which portions of the document are visible on the display 140. In other embodiment, the detection unit 160 may be configured to recognize the position of a scroll bar, a cursor position within the document or inputs entered by the user via input 130 to determine which portions of the document are viewed by the user. In still other embodiments, the detection unit 160 may be connected to a peripheral device for tracking the movement of the users head and/or eyes with respect to the display 140 and/or certain text on which the user is focused for determining which portions of the document or display 140 are viewed. In alternate embodiments, the detection unit 160 may be configured to detect and determine which portion of the document has been viewed in any suitable manner.

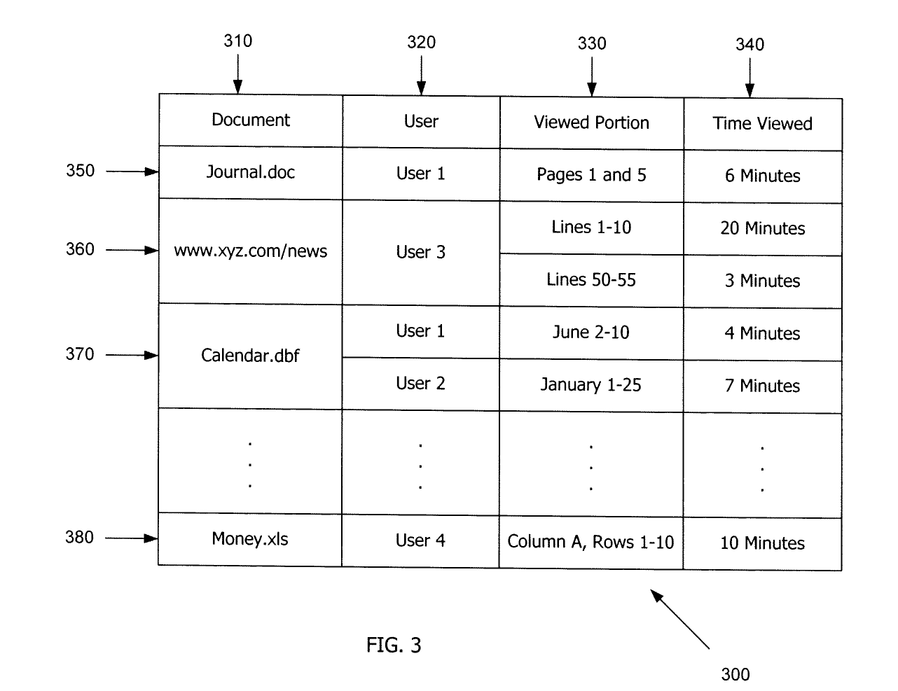

In this example, the detection unit is configured to cause the recordation or storing of data relating to which portions of the document are viewed (FIG. 2, Block 220). Data that is recorded and stored in, for example, the memory 120 includes, but is not limited to, the identity of the user viewing the document, the time spent by the user when viewing the document or a particular portion of the document, the pages viewed, line numbers viewed or any other suitable information. In this example, the data is stored in the exemplary table shown in FIG. 3. In other embodiments, the data may be stored in any suitable manner. It is noted that the table 300 is only exemplary in nature and may have any suitable number of rows and columns including any suitable information. In other embodiments, the information included in table 300 may be included as part of the respective document. The statistics or data pertaining to which portions of the document have been viewed such as, for example, the data shown in table 300, may be attached to the document as an attribute otherwise embedded within the document. For example, the file “journal.doc” shown in FIG. 3 may include as a file attribute the information included in columns 320-340, row 350. The file attributes can be updated as a viewer views the document or at any other suitable time. In alternate embodiments the statistics pertaining to which portions of the document have been viewed may be recorded, stored or transferred in any suitable manner and/or location.

The table in FIG. 3 includes any suitable information or data such as a document identification column 310, a user identification column 320, a viewed portion column 330 and a time viewed column 340. The document identification column 310 includes information pertaining to any suitable files including, but not limited to, word processor files 350, web sites 360, database files 370, spreadsheet files 380, video files, drawing files and image files. The user identification column 320 identifies a user viewing the document. The user identification is recorded, for example, when a document is sent to a list of people for review or for any other suitable reasons. The viewed portion column 330 includes any suitable information such as, for example, which portion of the document was viewed and the time viewed column 340 includes information pertaining to, for example, an amount of time a respective portion of the document was viewed. For example, referring to the row indicating the web site information 360, User 3 viewed lines 1-10 of the web site for twenty minutes and lines 50-55 of the website for three minutes. Referring to the database entry 370, User 1 viewed the dates between June 2^{nd} through June 10^{th} for four minutes while User 2 viewed the dated between January 1^{st} through January 25^{th} for seven minutes. The information in the table 300 may be presented to the user in any suitable manner such as those described below (FIG. 2, Block 230). In other embodiments the user may be able to access and view the table directly.

In other embodiments any suitable mathematical functions or algorithms may be utilized to determine which parts of a document have been reviewed and how well they have been reviewed. For example, mathematical functions can be used to provide a weighting system that indicates to a user how well portions the document has been read. The mathematical function may incorporate any suitable information, including but not limited to, the information shown in table 300 when determining which parts of a document have been reviewed and how well they have been reviewed. In alternate embodiments the determination of which portions of a document are read and how well they are read may be determined in any suitable manner.

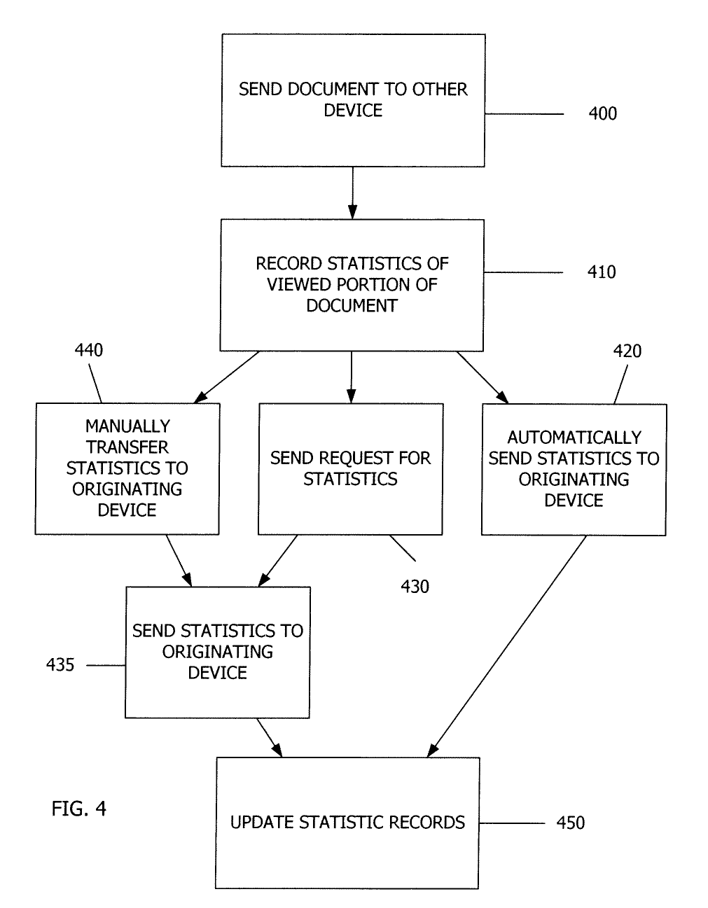

In this example, the table 300 is updated automatically or upon request by a user. For example, when a document is opened the user, viewed portion and time viewed information may be recorded in any suitable memory of the device on which the file is viewed. When the document is closed the recorded information is transferred to the device in which the table 300 is stored (if the table is stored in another device) for updating the table. For example, referring to FIG. 4, a user of a first device sends a document to a user of device B for review (FIG. 4, Block 400). The document is opened on device B and the data relating to which portions of the document are viewed are stored in a memory of device B (FIG. 4, Block 410). When the user of device B closes the document, device B automatically sends the data to device A for updating the table 300 (FIG. 4, Blocks 420 and 450). In other embodiments, the user of device A sends a request to device B for the data so that the table 300 can be updated (FIG. 4, Blocks 430, 435 and 450). In still other embodiments the user of device B may initiate the transfer of data for updating the table 300 (FIG. 4, Blocks 440, 435 and 450).

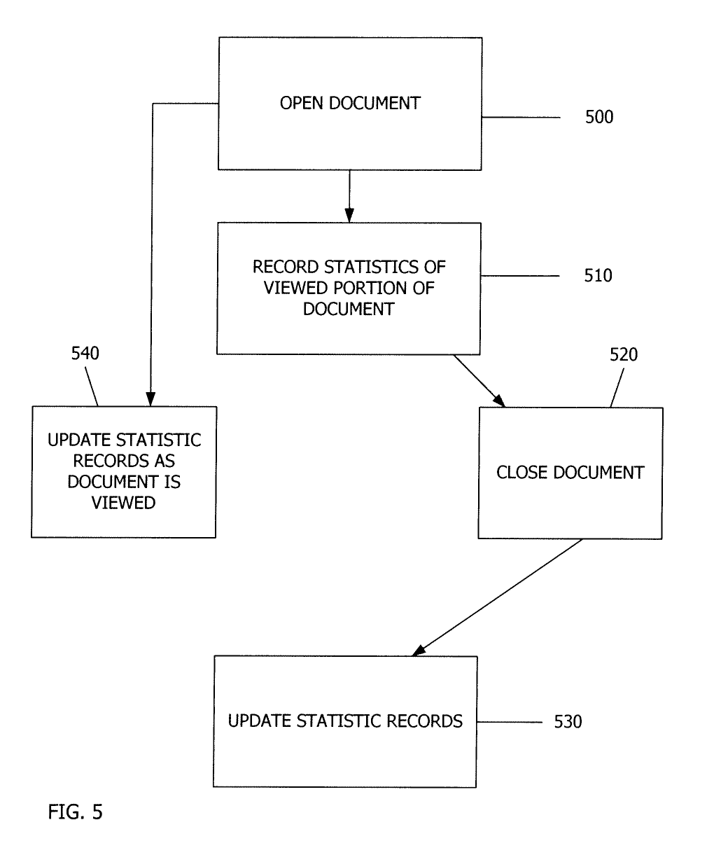

Referring to FIG. 5, in another example, where the document is opened on the device in which the table 300 is stored (FIG. 5, Block 500), the data relating to the portions of the document that are viewed are temporarily stored in a memory of the device (FIG. 5, Block 510). The table 300 may be updated with the data temporarily stored in the memory when the document is closed (FIG. 5, Blocks 520 and 530). In other embodiments, the table is updated on a real time basis as the document is viewed on the device in which the table is stored (FIG. 5, Block 540).

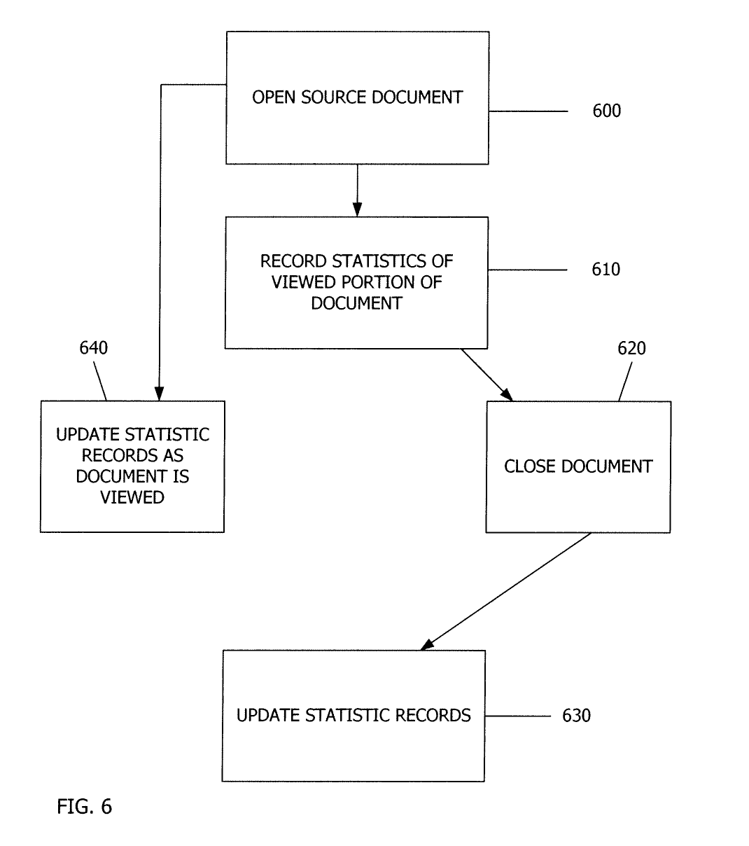

Referring to FIG. 6, in another example, where a source document is opened from a remote location (FIG. 6, Block 600) such as for example, a document opened over a network via a remote device or a web page viewed over the internet via the remote device, the data relating to the portions of the document that are viewed are temporarily stored in a memory of a host device (e.g. server computer and the like on which the source document is stored) (FIG. 6, Block 510). The table 300 is stored in the host device and updated with the data temporarily stored in the memory when the source document is closed (FIG. 6, Blocks 620 and 630). In other embodiments, the table 300 is updated on a real time basis as the source document is viewed (FIG. 6, Block 640).

In accordance with aspects of an embodiment, the statistical information relating to which portions of a document have been read are presented to a user or viewer in any suitable manner such as, for example, through the display 140 of the apparatus or a speaker of the apparatus. In one embodiment, the statistical information is presented to the user of the apparatus 100 automatically when the document is opened. In other embodiments the statistical information is presented to the user of the apparatus 100 upon request by the user. For example, the apparatus 100 may have an information function which when activated or selected presents the statistical information to the user. The information function is activated or selected in any suitable manner such as, for example, by pressing any suitable key on an input of the apparatus 100, selecting an icon on the display 140 of the apparatus or by selecting any suitable menu item of the apparatus. In still other embodiments, the information function may be provided as a plug-in that runs with a respective application of the apparatus such as for example, a text editor, image viewer, video player, music player and the like. In still other embodiments the information function is provided as part of an application of the apparatus. In alternate embodiments the information function may be provided in any suitable manner. It is noted that the user or viewer of the document may hide, close or otherwise resize the statistical information in any suitable manner so that the statistical information does not occupy any space on the display 140.

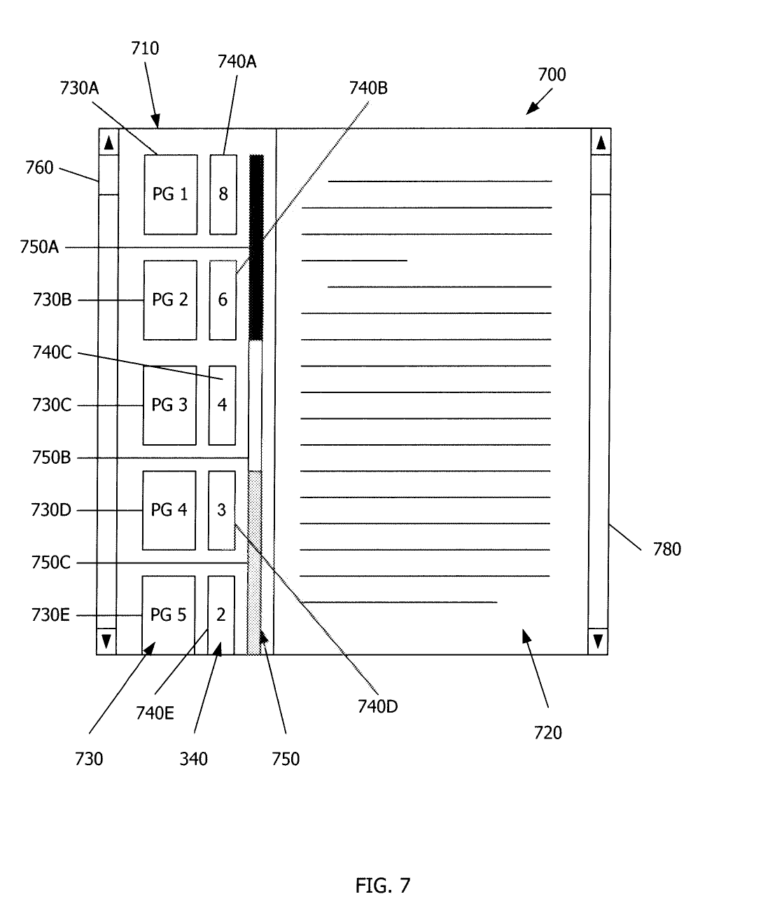

Referring now to FIG. 7, an exemplary display 300 of an apparatus 100 incorporating features of an embodiment is shown. As can be seen in FIG. 7, the display may include a document area 720 for displaying the document and a review status area 710 for indicating to the user which portions of the document have been reviewed. In this example, the review status area 710 includes a slider bar 760, a page representation column 730, a user column 740 and an indicator bar 750. The slider bar 760 allows a user to scroll through the statistical information presented on the display. The page representation column 730 includes a representation 730A-E of the individual pages of the document (e.g. “PG1” represents page one of the document, “PG2” represents page two of the document, etc.). The user column 740 includes indicators 740A-E corresponding to the total number of users that reviewed or viewed each page. For example, indicator 740A indicates eight users reviewed page 1, while indicator 740E indicates two users reviewed page 5. In other embodiments the user column 730 may include the individual users that reviewed a respective portion of the document. For example, instead of showing a total of two users viewed page five, the user column 740 may indicate that “user one” and “user two” viewed page 5. The indicator bar 750 represents how much time the users spent reviewing each portion of the document. The indicator bar may be a colored bar where the color represents an amount of time. For example, the black color 750A may represent a first amount of time, the white color 750B may represent a second amount of time and the gray color 750C may indicate a third amount of time. It is noted that any suitable colors may be used in the indicator bar 750. In this example, pages one and two have been reviewed for the first amount of time as indicated by color 750A. Page three has been reviewed for the second amount of time as indicated by color 750B. Pages four and five have been reviewed for the third amount of time as indicated by color 750C. In this example, the coloring of the indicator bar 750 corresponds to review time for whole pages but in other embodiments the coloring of the indicator bar may also indicate a review time for only a portion of a page. In alternate embodiments, the indicator bar may include a time a respective portion of the document has been reviewed such as, for example, instead of including the color 750A corresponding to the review time for page one the indicator bar 750 may include, for example, text that indicates page one has been reviewed for twenty minutes. A user may also utilize the review status area 710 to jump around the document. For example, the user can select “PG 3” in the review status area 710 so that the image of the document shown in the document portion 720 jumps to or changes to show page three of the document. In other embodiments, the document area 720 includes a slider bar 780 that is configured to jump to sections of the document that have not been read or reviewed. The review status area 710 may also include, for example, a column indicating the number of times a portion of a document has been viewed. In other embodiments the column 740 may represent the number of times a portion of the document has been viewed. For example, referring to FIG. 7, page 1 may have been viewed eight times.

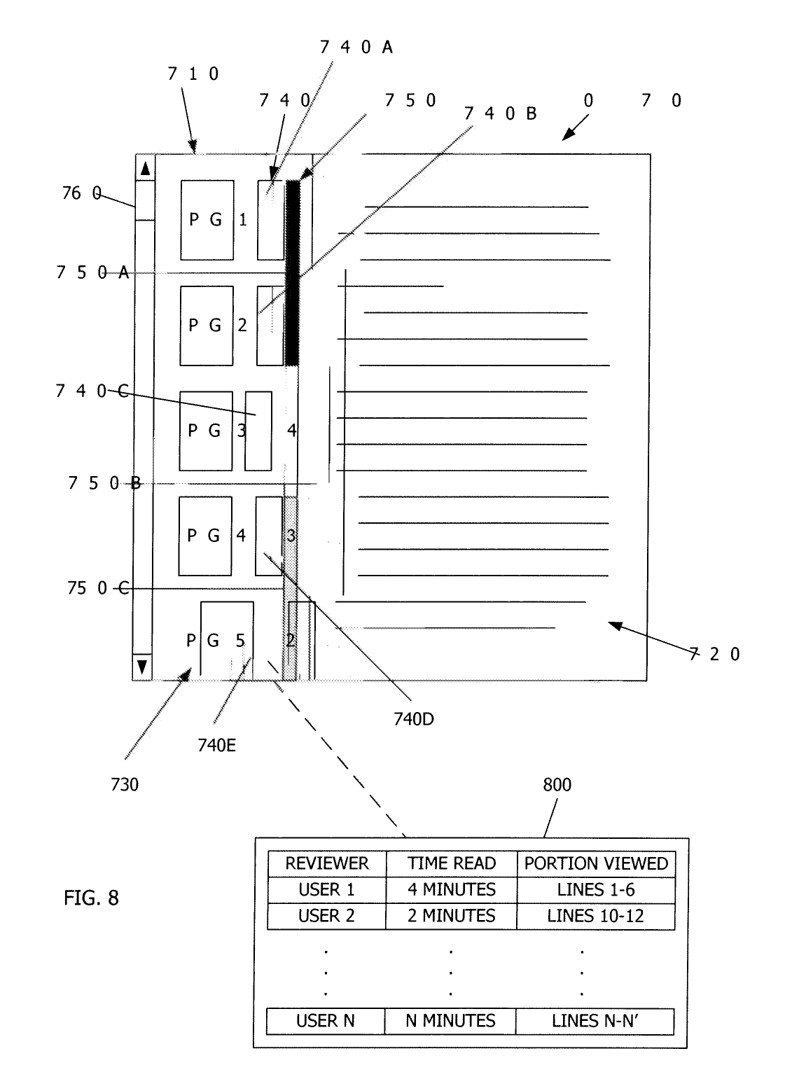

Referring to FIG. 8, in other embodiments, additional detailed information is presented to the user when the user selects or mouses over (i.e. place a cursor over) an object or piece of information included in the review status area 710. A user may select any one of the items or indicators (i.e. page representations 730A-E, user representations 740A-E or anywhere along the indicator bar) in the review status area 710 of the display 700 via for example, any suitable keys on an input of the apparatus or by placing the cursor over the item. In this example, when an item is selected a table 800 may be presented to the user providing the detailed information to the user. It is noted that the detailed information may be presented to the user in any suitable form and not necessarily in a tabular format. In FIG. 8 item 740E has been selected for the presentation of detailed information. The detailed information shown in table 800 corresponding to page five of the document details which users reviewed page five, for how long and which lines were reviewed. For example, “user 1” reviewed “lines 1-6” of page five for “4 minutes”. The table 800 may be any suitable size to accommodate any suitable number of users that have reviewed a respective portion of the document. In alternate embodiments the additional detailed information may include any suitable information relating to the document. In other embodiments the detailed information may be converted to speech via a text to speech editor for presentment to the user via a speaker of the apparatus.

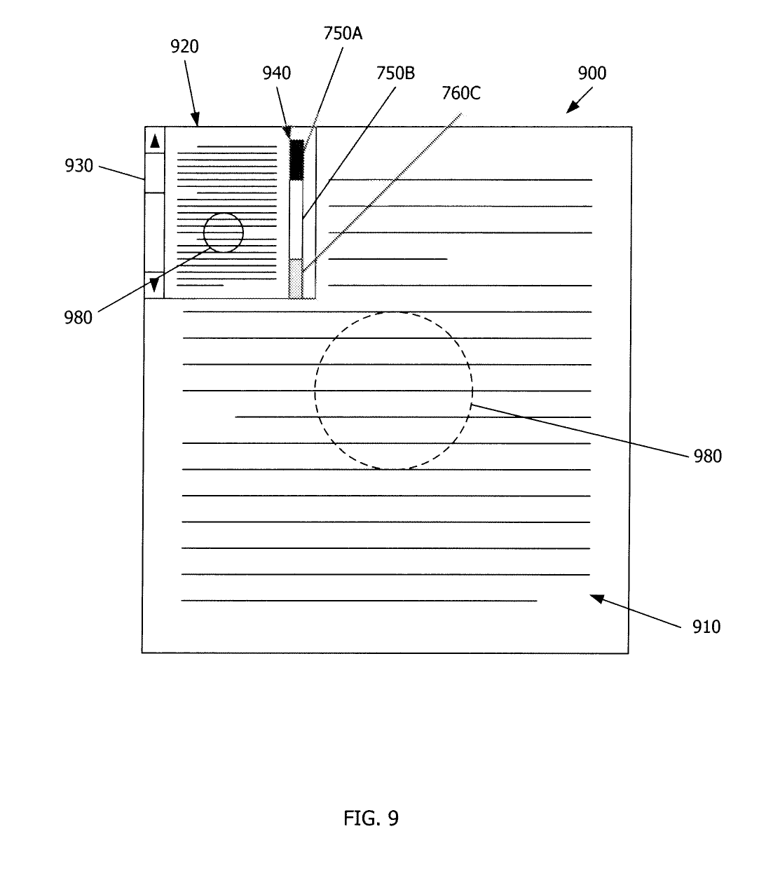

Referring to FIG. 9, another exemplary display 900 of an apparatus 100 incorporating features of an embodiment is shown. In this example, the display 900 includes a document area 910 and a review status area 920. In this example a single page document is shown such as for example, a web page, photograph, spreadsheet and the like. Here the review status area 920 is reduced version of the single page document but in alternate embodiments the review status area may have any suitable size or represent the document in any suitable manner. In this example, the review status area 920 includes an indicator bar 940 and a slider bar 930 which are substantially similar to those described above with respect to FIG. 7. Also, in this example, additional detailed information may be presented to the user in a manner substantially similar to that described above with respect to FIG. 8. As shown in FIG. 9, when the review status area 920 represents a reduced version of the document a user may mouse over or otherwise select a portion of the document in the review status area 920 so that the moused over or selected portion of the document is shown in the document area 910 of the display 900. For example, the user selects portion 980 of the document from the review status area 920 of the display 900 so that portion 980 of the document is presented in the document area 910 of the display.

In other embodiments, where images or spreadsheets (e.g. any document having rows and columns, non-textual information or documents too big to fit widthwise on the display) an additional indicator bar and/or scroll bar is provided so that a type of review matrix is set up. The review matrix allows the user to determine two dimensionally which portion of, for example, the image or spreadsheet has been reviewed or requires further review.

In another embodiment, the documents are sorted outside of the document viewer such as in, for example, a file listing. For example, the apparatus is configured to arrange the files so that when the user views a list of files in a file manager the files that have been not been read or have only been partially read are presented at the beginning of the list. Similarly, when a user opens, for example, a document in a word processor, the user is presented with a list of files to choose from where the files that have not been reviewed or have only been partially reviewed are presented first. In other embodiments the apparatus may be configured to arrange the files in any suitable manner.

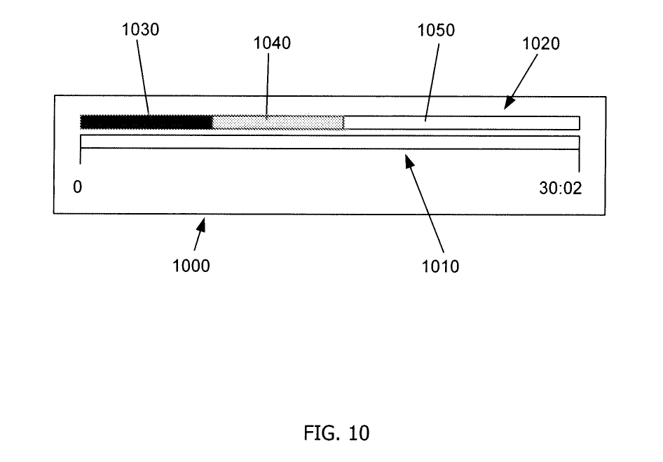

Referring now to FIG. 10, a time bar for a music or video player is shown in accordance with an embodiment. The time bar includes a progress indicator telling the user the total length of the sound track or video as well as what portion of the sound track or video the user is currently listening to or viewing. The time bar also includes a review status indicator 1020 that is substantially similar to the indicator bar 750 described above. In this example, the review status indicator is the same length as the progress indicator so that any given point on the review status indicator 1020 corresponds to a similar point of the progress indicator 1010. In this example, the color 1030 may indicate that the corresponding portion of the sound track or video has been listened to or viewed by the user. The color 1040 may indicate that the corresponding portion of the sound track or video has been, for example fast forwarded through. The color 1050 may indicate that the corresponding portion of the sound track or video has not been listened to or viewed. In other embodiments, the user may mouse over or select a portion of the progress bar to obtain a review status as described above.

It is noted that the exemplary embodiments shown in FIGS. 7-9 may be employed individually or in any combination. For example, a user may select item 730E (i.e. page 5) in FIG. 7 so that the review status area 710 changes to the review status area 920 shown in FIG. 9. When the review status area is changed page five of the document is shown in review status area 920. This provides a user a more detailed view of the individual pages in lieu of presenting a detailed table such as for example, table 800.

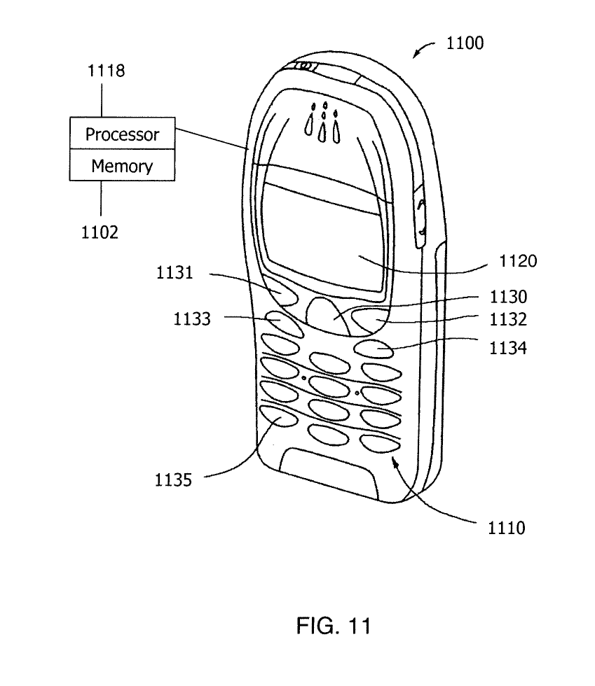

One embodiment of an apparatus 100 in which aspects of the disclosed embodiments may be employed is illustrated in greater detail in FIG. 11. The device may be any suitable device such as terminal or mobile communications device 1100. The terminal 1100 may have a keypad 1110 and a display 1120. The keypad 1110 may include any suitable user input devices such as, for example, a multi-function/scroll key 1130, soft keys 1131, 1132, a call key 1133 and end call key 1134 and alphanumeric keys 1135. The display 1120 may be any suitable display, such as for example, a touch screen display or graphical user interface. The display may be integral to the device 1100 or the display may be a peripheral display connected to the device 1100. A pointing device, such as for example, a stylus, pen or simply the user's finger may be used with the display 1120. In alternate embodiments any suitable pointing device may be used. In other alternate embodiments, the display may be a conventional display. The device 1100 may also include other suitable features such as, for example, a camera, loud speaker, connectivity port or tactile feedback features. The mobile communications device may have a processor 1118 connected to the display for processing user inputs and displaying information on the display 1120. A memory 1102 may be connected to the processor 1118 for storing any suitable information and/or applications associated with the mobile communications device 1100 such as software for the detection unit 160 described above, word processors, phone book entries, calendar entries, web browser, etc.

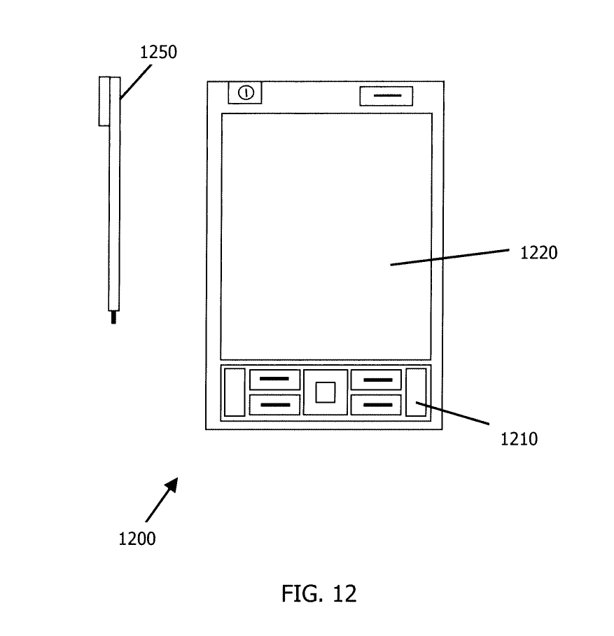

In one embodiment, the apparatus 100, may be for example, a PDA style device 1200 illustrated in FIG. 12. The PDA 1200 may have a keypad 1210, a touch screen display 1220 and a pointing device 1250 for use on the touch screen display 1220. In still other alternate embodiments, the device may be a personal communicator, a tablet computer, a laptop or desktop computer, a television or television set top box or any other suitable device capable of containing the display 1220 and supported electronics such as the processor 1118 and memory 1102.

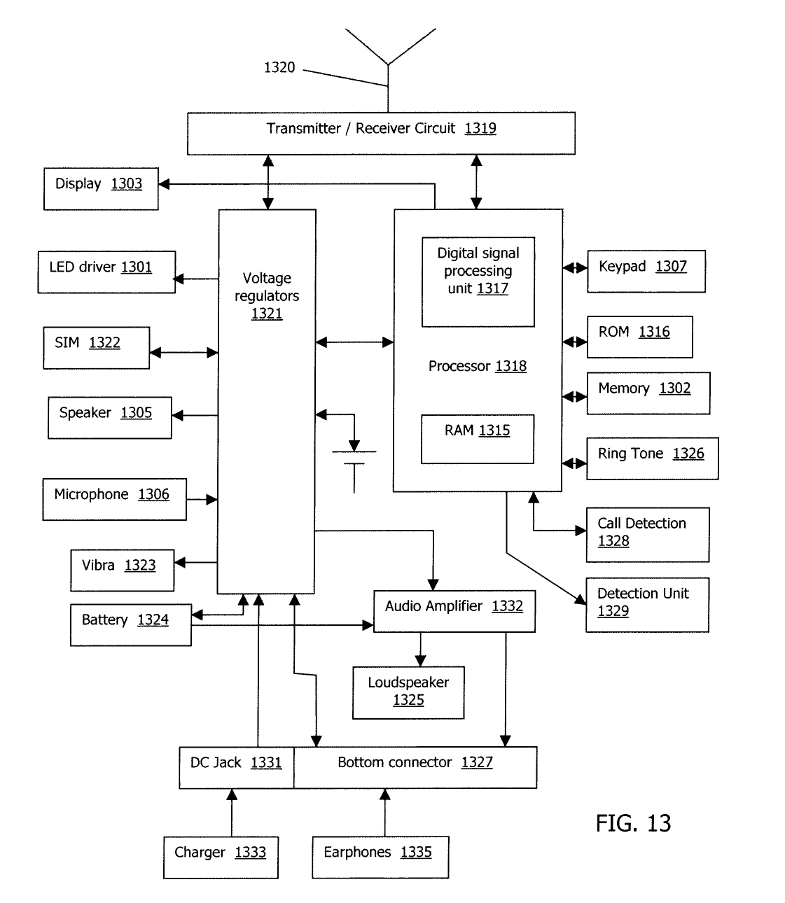

FIG. 13 illustrates in block diagram form one embodiment of a general architecture of a mobile device in which aspects of the embodiments may be employed. The mobile communications device may have a processor 1318 connected to the display 1303 for processing user inputs and displaying information on the display 1303. The processor 1318 controls the operation of the device and can have an integrated digital signal processor 1317 and an integrated RAM 1315. The processor 1318 controls the communication with a cellular network via a transmitter/receiver circuit 1319 and an antenna 1320. A microphone 1306 is coupled to the processor 1318 via voltage regulators 1321 that transform the user's speech into analog signals. The analog signals formed are A/D converted in an A/D converter (not shown) before the speech is encoded in the DSP 1217 that is included in the processor 1318. The encoded speech signal is transferred to the processor 1318, which e.g. supports, for example, the GSM terminal software. The digital signal-processing unit 1317 speech-decodes the signal, which is transferred from the processor 1318 to the speaker 1305 via a D/A converter (not shown).

The voltage regulators 1221 form the interface for the speaker 1305, the microphone 1306, the LED drivers 1301 (for the LEDS backlighting the keypad 1307 and the display 1303), the SIM card 1322, battery 1324, the bottom connector 1327, the DC jack 1331 (for connecting to the charger 1333) and the audio amplifier 1332 that drives the (hands-free) loudspeaker 1325.

A processor 1218 can also include memory 1302 for storing any suitable information and/or applications associated with the mobile communications device such as phone book entries, calendar entries, etc.

The processor 1318 also forms the interface for peripheral units of the device, such as for example, a (Flash) ROM memory 1316, the graphical display 1303, the keypad 1307, a ringing tone selection unit 1326, an incoming call detection unit 1328 and the detection unit 1329. Detection unit 1329 may be substantially similar to detection unit 160 described above. In alternate embodiments, any suitable peripheral units for the device can be included.

The software in the RAM 1315 and/or in the flash ROM 1316 contains instructions for the processor 1318 to perform a plurality of different applications and functions such as, for example, those described herein.

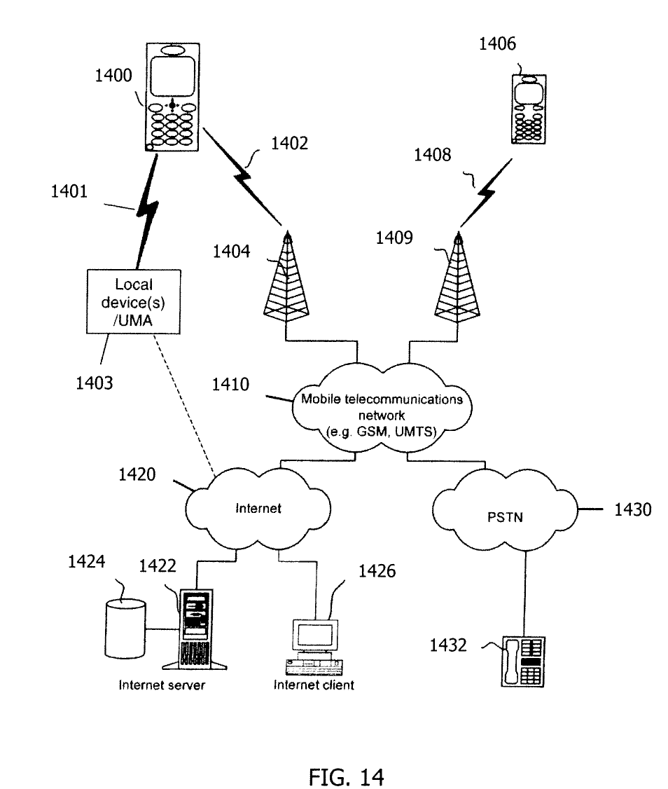

FIG. 14 is a schematic illustration of a cellular telecommunications system, as an example, of an environment in which a communications device 1400 incorporating features of an embodiment may be applied. Communication device 1400 may be substantially similar to that described above with respect to apparatus 100. In the telecommunication system of FIG. 14, various telecommunications services such as cellular voice calls, www/wap browsing, cellular video calls, data calls, facsimile transmissions, music transmissions, still image transmission, video transmissions, electronic message transmissions and electronic commerce may be performed between the mobile terminal 1400 and other devices, such as another mobile terminal 1406, a stationary telephone 1432, or an internet server 1422. It is to be noted that for different embodiments of the mobile terminal 1400 and in different situations, different ones of the telecommunications services referred to above may or may not be available. The aspects of the invention are not limited to any particular set of services in this respect.

The mobile terminals 1400, 1406 may be connected to a mobile telecommunications network 1410 through radio frequency (RF) links 1402, 1408 via base stations 1404, 1409. The mobile telecommunications network 1410 may be in compliance with any commercially available mobile telecommunications standard such as GSM, UMTS, D-AMPS, CDMA2000, FOMA and TD-SCDMA.

The mobile telecommunications network 1410 may be operatively connected to a wide area network 1420, which may be the internet or a part thereof. An internet server 1422 has data storage 1424 and is connected to the wide area network 1420, as is an internet client computer 1426. The server 1422 may host a www/hap server capable of serving www/hap content to the mobile terminal 1400.

For example, a public switched telephone network (PSTN) 1430 may be connected to the mobile telecommunications network 1410 in a familiar manner. Various telephone terminals, including the stationary telephone 1432, may be connected to the PSTN 1430.

The mobile terminal 1400 is also capable of communicating locally via a local link 1401 to one or more local devices 1403. The local link 1401 may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The local devices 1403 can, for example, be various sensors that can communicate measurement values to the mobile terminal 1400 over the local link 1401. The above examples are not intended to be limiting, and any suitable type of link may be utilized. The local devices 1403 may be antennas and supporting equipment forming a WLAN implementing Worldwide Interoperability for Microwave Access (WiMAX, IEEE 802.16), WiFi (IEEE 802.11x) or other communication protocols. The WLAN may be connected to the internet. The mobile terminal 1400 may thus have multi-radio capability for connecting wirelessly using mobile communications network 1410, WLAN or both. Communication with the mobile telecommunications network 1410 may also be implemented using WiFi, WiMax, or any other suitable protocols, and such communication may utilize unlicensed portions of the radio spectrum (e.g. unlicensed mobile access (UMA)).

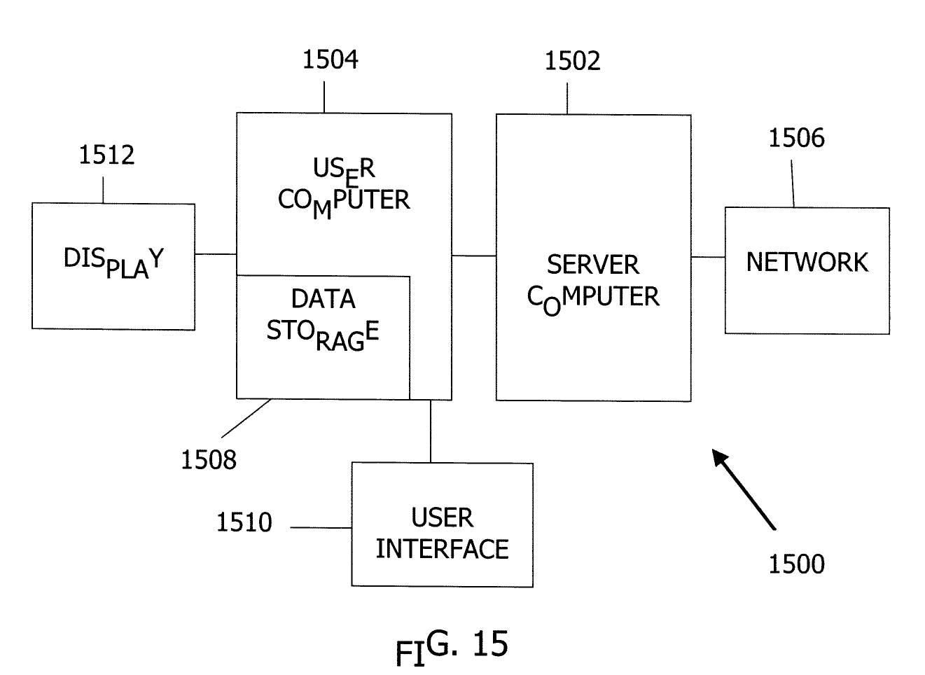

The disclosed embodiments may also include software and computer programs incorporating the process steps and instructions described herein that are executed in different computers. FIG. 15 is a block diagram of one embodiment of a typical apparatus 1500 incorporating features that may be used to practice aspects of the embodiments. As shown, a computer system 1502 may be linked to another computer system 1504, such that the computers 1502 and 1504 are capable of sending information to each other and receiving information from each other. In one embodiment, computer system 1502 could include a server computer adapted to communicate with a network 1506. Computer systems 1502 and 1504 can be linked together in any conventional manner including, for example, a modem, hard wire connection, or fiber optic link. Generally, information can be made available to both computer systems 1502 and 1504 using a communication protocol typically sent over a communication channel or through a dial-up connection on ISDN line. Computers 1502 and 1504 are generally adapted to utilize program storage devices embodying machine readable program source code, which is adapted to cause the computers 1502 and 1504 to perform the method steps disclosed herein. The program storage devices incorporating aspects of the invention may be devised, made and used as a component of a machine utilizing optics, magnetic properties and/or electronics to perform the procedures and methods disclosed herein. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 1502 and 1504 may also include a microprocessor for executing stored programs. Computer 1502 may include a data storage device 1008 on its program storage device for the storage of information and data. The computer program or software incorporating the processes and method steps incorporating aspects of the invention may be stored in one or more computers 1502 and 1504 on an otherwise conventional program storage device. In one embodiment, computers 1502 and 1504 may include a user interface 1510, and a display interface 1512 from which aspects of the invention can be accessed. The user interface 1510 and the display interface 1512 can be adapted to allow the input of queries and commands to the system, as well as present the results of the commands and queries.

It is noted that the embodiments described herein can be reformatted in any suitable manner such as, for example, in size, shape and/or content so that aspects of the embodiments can be implemented on any suitable electronic devices or any suitable display having any suitable shape or size.

As described above, the disclosed embodiments may generally allow a user to determine which portions of a document have been previously viewed by the user or by other people. In accordance with the disclosed embodiments, information pertaining to which portions of documents a viewer has reviewed is gathered. This information allows the author or creator of the document to see which parts of the document have been read or checked by others and which parts of the document require further reading or review. The information may provide data relating to which portions of a document a reader or viewer finds most interesting. The information may also provide a way to keep track of what portions of a document a reader has already read when the reading of the document takes place over one or more reading sessions so that the reader does not have to re-read or skim through the document to find out where the reader stopped reading.

It should be understood that the foregoing description is only illustrative of the embodiments. Various alternatives and modifications can be devised by those skilled in the art without departing from the embodiments. Accordingly, the disclosed embodiments are intended to embrace all such alternatives, modifications and variances that fall within the scope of the appended claims.

What is claimed is:

1. A method comprising:
opening a document application in a device;
determining in the device which sections of a document associated with the application have been reviewed; and
automatically highlighting the reviewed sections.

2. The method of claim 1, wherein automatically highlighting the reviewed sections includes providing indicators regarding which users reviewed a respective viewed section of the document, a description of at least one reviewed section of the document, a duration of time the at least one reviewed section of the document was reviewed and a number of times the at least one reviewed section of the document was reviewed.

3. The method of claim 2, wherein the duration of time the at least one reviewed portion of the document was reviewed is determined by calculating a duration of time the at least one reviewed portion is visible to the user.

4. The method of claim 2, wherein the duration of time the at least one reviewed portion of the document was reviewed is determined by monitoring eye or head movements of the user.

5. The method of claim 2, wherein the duration of time the at least one reviewed portion of the document was reviewed is determined by monitoring the position of a scroll bar or cursor position within the document.

6. The method of claim 1, wherein the document comprises one or more of a word processor document, spreadsheet, web page, word pad entry, calendar entry, drawing, photograph, video image, still image, slide show, electronic book, electronic mail or a message.

7. The method of claim 1, wherein automatically highlighting the reviewed sections includes indicating the reviewed section with one or more of an image or text.

8. The method of claim 7, wherein the image includes a plurality of colors where each of the plurality of colors represents a duration of time a respective one of the reviewed sections of the document has been reviewed.

9. An apparatus comprising:
a display;
a detection unit configured to determine which sections of a document are reviewed; and
a processor connected to the display and detection unit, the processor being configured to mark the reviewed sections of the document and present an indication of the marked sections to a user through at least the display.

10. The apparatus of claim 9, wherein the indication of the marked section includes one or more of a user who viewed a respective reviewed section of the document, a description of the at least one reviewed section of the document, a duration of time a respective reviewed section of the document was reviewed and a number of times a respective section of the document was reviewed.

11. The apparatus of claim 10, wherein the detection unit is configured to determine the duration of time the respective reviewed section of the document was reviewed by calculating a duration of time the respective reviewed section is visible to the user.

12. The apparatus of claim 10, wherein the detection unit is configured to determine the duration of time the respective reviewed section of the document was reviewed by monitoring eye or head movements of the user.

13. The apparatus of claim 9, wherein the document comprises one or more of a word processor document, spreadsheet, web page, word pad entry, calendar entry, drawing, photograph, video image, still image, slide show, electronic book, electronic mail or a message.

14. The apparatus of claim 9, wherein the indication of the marked section includes one or more of an image or text.

15. The apparatus of claim 14, wherein the image includes a plurality of colors where each of the plurality of colors represents a duration of time a respective one of the reviewed sections of the document has been reviewed.

16. The apparatus of claim 9, wherein the apparatus comprises a mobile communication device.

17. A computer program product comprising:
a computer useable medium having computer readable code means embodied therein for causing a computer to automatically highlight reviewed sections of a document, the computer readable code means in the computer program product comprising:
computer readable program code means for causing a computer to open a document application in a device;
computer readable program code means for causing a computer to determine in the device which sections of a document associated with the application have been reviewed; and
computer readable program code means for causing a computer to automatically highlight the reviewed sections.

18. The computer program product of claim 17, wherein automatically highlighting the reviewed sections further includes providing indicators regarding which users reviewed a respective section of the document, a description of at least one reviewed section of the document, a duration of time the at least one reviewed section of the document was reviewed and a number of times the at least one reviewed section of the document was reviewed.

19. The computer program product of claim 18, wherein the duration of time the at least one reviewed section of the document was reviewed is determined by calculating a duration of time the at least one viewed section is visible to the user.

20. The computer program product of claim 17, wherein the document comprises one or more of a word processor document, spreadsheet, web page, word pad entry, calendar entry, drawing, photograph, video image, still image, slide show, electronic book, electronic mail or a message.

21. The computer program product of claim 17, wherein automatically highlighting the reviewed sections of the document includes indicating the reviewed section with one or more of an image or text.

22. The computer program product of claim 21, wherein the image includes a plurality of colors where each of the plurality of colors represents a duration of time a respective one of the re viewed sections of the document has been reviewed.
